(19) United States
(12) Patent Application Publication
(10) Pub. No.: US 2026/0003058 A1
(43) Pub. Date: Jan. 1, 2026

(54) METHOD FOR DETECTING A USER MOVEMENT

(71) Applicant: HELLA GMBH & CO. KGAA, Lippstadt (DE)

(72) Inventors: Roman Curkin, Lippstadt (DE); Oliver Kirsch, Wuppertal (DE); Joachim Olk, Lippstadt (DE); Ludger Weghaus, Lippstadt (DE)

(21) Appl. No.: 19/252,107

(22) Filed: Jun. 27, 2025

(30) Foreign Application Priority Data
Jul. 1, 2024 (DE) 102024118560.0

(51) Int. Cl. G01S 13/56; G01S 7/41; G01S 13/02; G01S 13/88

(52) U.S. Cl. CPC G01S 13/56; G01S 7/41; G01S 13/0209; G01S 13/88

(57) ABSTRACT

The invention relates to a method for detecting a user movement within a vehicle. The method includes: (a) transmitting, using a transmitting antenna of a vehicle, a transmitting sequence; (b) receiving, using a receiving antenna, a receiving sequence, the receiving sequence being configured at least partially as a function of the transmitting sequence reflected at a user of the vehicle; (c) transmitting the receiving sequence to an electronic control unit (ECU) of the vehicle; (d) determining, by the ECU, a user movement of the user as a function of the receiving sequence; and (e) operating, by the ECU, the vehicle as a function of determining step. Further, the invention relates to a corresponding computer program product, a computer-readable data carrier, an ECU, and a vehicle.

### CROSS-REFERENCE TO RELATED APPLICATIONS

The present application claims the benefit of German Patent Application No. 10-2024-118-560.0, filed Jul. 1, 2024, the disclosure of which is incorporated by reference.

### BACKGROUND OF THE INVENTION

The invention relates to a method, a computer program product, a computer-readable data carrier, an electronic control unit, and a vehicle.

Electric vehicles with movable parts, such as doors and/or trunk lids, which conceal access to the vehicle interior are well known. These movable parts can be opened by a user (e.g. the driver) of the vehicle. Preferably, the user can open the movable part using a (mobile) identification transmitter (e.g. a key and/or a smartphone).

The state of the art has disadvantages. For example, opening and/or unlocking the movable parts cannot be easily achieved. In particular, the recognition of an opening request, e.g. via a user movement, is not possible or not possible in an optimized manner. For example, detection may not be carried out and/or may be optimizable. The complexity of recognition, detection and/or authentication can also be optimized. For example, several and/or different sensors, such as capacitive sensors, may be necessary, which may not function or not function optimally due to moisture and/or contamination (from ice, water, dirt on or at the sensor). It may also be the case that (already) existing sensors are not included or not sufficiently included, for example to detect a user movement.

It is therefore an object of the present invention to at least partially overcome at least one of the disadvantages described above. In particular, it is the object of the invention to provide an improved method for detecting a user movement. Further, it may be an object to optimize costs, weight, redundancy, reliability, (spatial) coverage and/or complexity.

### SUMMARY OF THE INVENTION

The above object is achieved by a method, a computer program product, a computer-readable data carrier, an electronic control unit, and a vehicle. Further features and details of the invention are apparent from the description and the drawings. Features and details described in connection with the invention of course also apply in connection with the computer program product according to the invention and/or in connection with the computer-readable data carrier according to the invention and/or in connection with the electronic control unit according to the invention and/or in connection with the vehicle according to the invention, and vice versa in each case, so that reference is or can always be made to the individual aspects of the invention with respect to the disclosure. In particular, advantages described in the first, second, third, fourth and/or fifth aspect also apply to the first, second, third, fourth, and/or fifth aspect, respectively.

The above object is achieved according to a first aspect by a method for detecting a user movement of a user in a vehicle (in particular according to the fifth aspect), in particular for detecting a presence and/or an opening request of a user at or in the vehicle, comprising:
transmitting, using a transmitting antenna of a vehicle, a transmitting sequence,
receiving, using a receiving antenna, a receiving sequence, the receiving sequence being designed at least partially as a function of the transmitting sequence reflected at a user of the vehicle,
transmitting the receiving sequence to an electronic control unit of the vehicle,
determining, by the electronic control unit, a user movement of the user as a function of the receiving sequence, and
operating, by the electronic control unit, the vehicle as a function of determining.

The method according to the first aspect may be computer-implemented and/or may be carried out repeatedly and/or continuously. Preferably, the method can be carried out when, before and/or (preferably) while operating or using a vehicle and/or an electronic control unit, for example while the vehicle is turned off and/or parked. Alternatively or additionally, the method can be carried out at (regular) intervals. It is conceivable, for example, that the method is carried out while a vehicle, in particular an (electric) vehicle, is turned off, for example during a charging process. It is also conceivable that the method is activated when a user, in particular a smartphone set up for this purpose and/or an identification transmitter (for authenticating the user) is recognized in the (immediate) vicinity around the vehicle (for example by communication with the electronic control unit, e.g. via a [separate] transmitting and/or receiving unit). The electronic control unit can (at least partially) implement the method, for example by (combined) carrying out of the (above-mentioned) steps and/or by controlling corresponding components (e.g. the sensors). The method allows a user movement, such as a kicking movement, e.g. in the rear area of the vehicle, to be processed and/or detected more efficiently, more accurately, more reliably, more cost-effectively, with less weight and/or more quickly.

In the context of the invention, a vehicle may comprise a motor vehicle and/or a truck. In particular, a vehicle may comprise an electric vehicle, in particular comprising a movable part, preferably a (side) door and/or a trunk (lid). The movable part can be opened and/or controlled during operating, for example (controlled) by a control signal, whereupon it preferably opens (automatically). The electronic control unit can be set up to operate the vehicle and/or the sensor(s). Preferably, a user movement, which can preferably be specific to an opening request by the user, e.g. a kicking movement (such as in the rear area of the vehicle), can be detected. If this user movement is detected (by the control unit), a control signal can be transmitted to the movable part (in particular an actuator), whereupon the movable part is unlocked and/or opened. It can preferably be provided that this occurs (only) if (at the same time and/or shortly before) an authentication process has been (successfully) completed, for example if the user is carrying a (suitable) mobile ID transmitter. Alternatively or additionally, it may also be provided that the method can recognize a person and/or a living being inside the vehicle. Accordingly, a presence can (also) be detected inside the vehicle. For example, the method can be used to recognize a user's opening request from outside. Alternatively or additionally, the method can also be used to recognize (left behind) living beings (persons, in particular children, and/or animals), for example when the vehicle has (just) been locked and/or at (regular) intervals, e.g. every 2 minutes. Preferably, this can increase safety.

Transmitting, using a transmitting antenna of a vehicle, a transmitting sequence, and/or receiving can be carried out in parallel, continuously and/or over a (predefined) period of time. The transmitting sequence can be emitted by the transmitting antenna during transmitting. The transmitting sequence can be designed periodically. The transmitting sequence may comprise one or a plurality of pulse radio signals, in particular electromagnetic waves, radar and/or ultra-wideband (UWB) waves. Preferably, the transmitting sequence is repeated.

When receiving, using a receiving antenna, a receiving sequence, the receiving sequence is designed at least partially as a function of the transmitting sequence reflected at a user of the vehicle. Accordingly, the transmitting sequence can be (at least partially) reflected back to a user. The receiving antenna can therefore receive an echo. Preferably, receiving can occur simultaneously with transmitting and/or the transmitting sequence. A receiving sequence can comprise a received signal and/or echo, in particular of the transmitting sequence. Accordingly, the receiving sequence can be designed periodically. There may be a path delay (“fast time”) between the transmitting sequence, in particular a time at which the transmitting sequence or part of it is emitted, and the receiving sequence, in particular at a later time. Successive points in time (or transmission pulses) of the transmitting sequence can be characterized by the so-called “slow time”. The receiving sequence can contain received raw data and/or, in particular as a function of the transmitting sequence, a (time-invariant) channel impulse response. The receiving sequence can comprise (received and/or reflected) pulse radio signals, electromagnetic waves, radar and/or UWB waves. The transmitting antenna and/or receiving antenna can be operated in a “radar mode” and/or “multi-static radar mode”.

The transmitting antenna can be set up to transmit a transmitting sequence. It can also be provided that the transmitting antenna is (also) set up for receiving. This means that the method can be realized with just one or a few antennas. It may be provided that the receiving antenna is set up for receiving. Preferably, the transmitting antennas and the receiving antenna are phase-synchronized. Preferably, the transmitting antenna and the receiving antenna can be integrated in a so-called UWB anchor. This allows the transmitting and receiving signals to be scanned in a frequency and phase-synchronized manner. This allows the method to be realized with (only) one sensor or antenna. Preferably, the transmitting and/or receiving antenna can be set up to carry out and/or provide further functions for the vehicle, for example as a distance meter for a parking assistance system. This eliminates the need for additional and/or separate antennas. Distance sensors or antennas can already be provided on vehicles. It may also be provided that the transmitting antenna and the receiving antenna are separate and/or separated from one another. For example, it may be provided that a first antenna, in particular a UWB antenna, is used, comprising a transmitting antenna for transmitting (and/or a receiving antenna). For example, it may be provided that a second antenna, in particular a UWB antenna, is used, comprising a receiving antenna for receiving (and/or a transmitting antenna). Accordingly, the first antenna can be used for transmitting and the second antenna for receiving. This can increase the signal-to-noise ratio (SNR), in particular because separate antennas can provide better decoupling. It may be provided that different antennas, in particular a first and a second antenna, are designed to be phase-synchronized. The first and second antennas can be arranged at a distance from one another, preferably at a distance of half the wavelength. This allows directional information to be provided in addition to distance information, for example by means of the phase difference of the receiving sequences between the two antennas. It may also be provided that the first and/or second antenna are used alternately for transmitting and/or receiving. This may allow validation of the results. It may be provided that receiving, transmitting and/or determining comprises converting and/or digitizing, for example by an analog-to-digital converter. An (analog) receiving sequence can be digitized and/or concretized. Accordingly, the receiving sequence and/or the channel impulse response can be designed to be time-variant and/or time-dependent. In other words, it can have a temporal sequence of signal (parts). It may be provided that the channel impulse response is provided (directly) by the receiving antenna. Alternatively, it can be calculated by the electronic control unit as a function of the transmitting sequence and the receiving sequence. For example, it may be provided that a receiving sequence may comprise 16 (consecutive) receiving sequence parts or channel impulse responses (e.g. over a period of 12 ms). Such a sequence may, for example, be measured over a measurement period. Preferably, transmitting and/or receiving or the method is then repeated. This allows a user movement to be detected over a longer period of time, e.g. several seconds or minutes. Preferably, it may be provided that the transmitting and/or receiving antenna is set up in the vehicle in order to enable vehicle access and/or start permission, in particular using a suitable smartphone. Particularly preferably, the method according to the first aspect can be realized (additionally) in the process or as a result thereof, which advantageously means that no additional hardware is required.

Transmitting the receiving sequence to an electronic control unit of the vehicle can be carried out via a (wired and/or wireless) data connection. Accordingly, the transmitting antenna and/or receiving antenna can be connected to the electronic control unit via a (respective) data connection. The electronic control unit can control the transmitting antenna to carry out transmitting. The electronic control unit can receive the receiving sequence and/or the (different) channel impulse responses from the receiving antenna.

Operating the vehicle, by the electronic control unit, as a function of determining may, for example, comprise operating the moving part. For example, if the electronic control unit detects a user movement during determining, it can transmit a control signal to the movable part. This allows the movable part to be unlocked and/or opened, for example via an actuator, as a function of the control signal. This can, for example, lead to unlocking and/or opening of the movable part (e.g. the trunk lid) as a function of a user movement (e.g. a kicking movement in the rear area below the trunk). Alternatively or additionally, an acoustic and/or visual warning can be issued if a user movement has been detected and/or has not been detected (or has been detected incorrectly).

In the context of the invention, it may be advantageous for the transmitting antenna and/or the receiving antenna to be designed as an ultra-wideband antenna, and for transmitting of a transmitting sequence to have a bandwidth of at least 500 MHz.

For example, a transmitting frequency specific to the transmitting sequence and/or a receiving frequency specific to the receiving sequence can be between 3 and 10 GHz, in particular 4 to 8 GHz, preferably between 5 and 6.5 GHz.

In the context of the invention, it is conceivable that receiving or determining comprises calculating a, in particular a time-invariant, channel impulse response as a function of the receiving sequence.

The receiving sequence and/or the channel impulse response(s) may be designed in a complex-valued manner. The receiving sequence may have a received time-dependent signal, which can be represented, for example, as a receiving vector or receiving matrix, in particular as a distance-amplitude matrix (or also as a range-amplitude matrix). Preferably, it may be provided if a (first and/or second) antenna or a receiving antenna provides the channel impulse response(s) directly. In this case, it may be provided that the receiving sequence and/or channel impulse response(s) are transmitted to the electronic control unit. The channel impulse response(s) can be determined, for example, by an (auto) correlation between the transmitting sequence and the receiving sequence, a 1D Fourier transform (or FFT) along the columns (of the receiving matrix) and/or a further 1D Fourier transform (or FFT) along the rows (of the receiving matrix). Continuous repetition, in particular of the correlation between the transmitting sequence and the receiving sequence, enables spatial changes to be detected, in particular as a function of a user movement, e.g. a kicking movement or even a breathing movement. The channel impulse response can have a matrix or be represented and/or processed in matrix form.

In the context of the invention, it may be provided that determining comprises calculating a two-dimensional Fourier transform, in particular a Fast Fourier transform, as a function of the receiving sequence, in particular the channel impulse response, in order to obtain a distance-velocity map.

The electronic control unit can calculate the distance-velocity map (also called range-velocity map) as a function of the receiving sequence, in particular the channel impulse response. Calculating can be carried out using a two-dimensional Fourier transformation, in particular a fast Fourier transformation (FFT). For example, the distance-velocity map (as a result) can be represented in matrix form and/or have (so-called) bins (or individual and/or discrete values or fields). The distance to a user or object (e.g. in [m], e.g. from −1 to 3.5 m) can be represented along the x-direction, and/or the velocity of the object or user (e.g. in [m/s], e.g. from −0.7 to +0.7 m) can be represented along the y-direction. For example (to refer back to the example above), 16 bins can be arranged (consecutively) in the distance-velocity map (in each case) in a column (along the y-direction). For example, (to refer back to the above) 32 bins can be arranged (consecutively) in the distance-velocity map (in each case) along the x-direction. The 2D FFT can, for example, exhibit a scale or values between 0 and 100 dB. The 2D FFT can, in particular with regard to the y-direction, exhibit positive values for the upward velocity and/or negative values for the downward velocity. For example, a value of 0 m/s can be positioned in the middle. It may be provided that in an upper half (the upper bins) of the channel impulse response are specific for a movement in the direction of and/or towards the receiving antenna (e.g. kicking movement of the leg in the direction of the vehicle and/or receiving antenna). It may be provided that in a lower half (the lower bins) of the channel impulse response are specific to a movement away from the receiving antenna (e.g. retraction of the user's leg during a kicking motion). It may be provided that calculating comprises filtering, wherein amplitude values below an amplitude limit value are set to 0. This can improve accuracy and/or efficiency. For example, the amplitude limit can be 40 dB, preferably 30 dB.

It is further conceivable that determining comprises forming, in particular repeatedly, a first sum (for positive bins or velocities and/or which is time-variant) and a second sum (for negative bins or velocities and/or which is time-variant) as a function of the receiving sequence, in particular the distance-velocity map, the first sum being specific to a movement of the user, in particular of a leg of the user, towards the receiving antenna and/or transmitting antenna, wherein the second sum is specific to a movement of the user, in particular of a leg of the user, away from the receiving antenna and/or transmitting antenna.

Forming a first sum and/or second sum may comprise summing up the or specific values of the distance-velocity map, preferably in a first and/or second (rectangular) range, e.g. with a width of 8 bins along the distance direction (x-direction) and 7 (or 8) bins along the velocity direction (y-direction). Forming a first and/or second sum can be carried out repeatedly, in particular for individual, different and/or successive channel impulse responses. Accordingly, a time curve for the first and/or second sum can be determined, which is preferably specific for a user movement, in particular in the direction of the receiving antenna and/or away from the receiving antenna. The first and/or second area can be predefined, e.g. with a width of 8 bins along the distance direction (x-direction) and 7 (or 8) bins along the velocity direction (y-direction). It may also be that the first and/or second range (or their size) is carried out as a function of a calibration and/or historical data for a vehicle and/or a (specific) user. Accordingly, determining can be carried out specifically for a particular user (e.g. the driver and/or owner) of a vehicle. This can increase safety and/or reliability (of a detection). This is based on the idea that a particular user (preferably) always carries out a substantially identical user movement, e.g. kicking movement. Alternatively or additionally, it may be provided that the first and/or second sum, in particular the width or number of bins used for their calculation, are determined as a function of a threshold value which is specific to the bins. For example, a threshold value of at least 50% of the maximum value can be used. It may be preferable for a velocity of and/or around 0 m/s (or corresponding bins) to be ignored. This allows static objects (such as a curb) to be filtered out. A larger first and/or second range, in particular a larger width in the velocity direction, can detect slower and/or faster movements. A smaller first and/or second range, in particular a smaller width in the velocity direction, can exhibit less interference and/or enable a better signal-to-noise ratio (SNR). The first and second ranges are preferably the same size.

It is also conceivable that determining comprises folding the receiving sequence, wherein in particular the first sum is folded with the second sum in order to obtain a convolution function.

The first sum and/or second sum can preferably exhibit a time dependency. In this way, a first sum and/or second sum can be formed for (in each case) a distance-velocity map. One or more temporally (later) distance-velocity map(s) can generate a temporally later value for the first and/or second sum. The (mathematical) folding (or convolution) of the first and second sum can be carried out. This can provide improved accuracy for the detection of user movement. It may be provided that the convolution function (the result) is designed to be time-dependent. For example, in the simplest case, the convolution function can have a peak, e.g. a roughly parabolic (downwardly open) curve. It may be provided that recognizing a section of the convolution function is carried out, wherein the section is specific to (exactly one) user action. This can be done, for example, by pattern recognition. Alternatively or additionally, it may be provided that a section, which is preferably specific to a (single) user movement, is determined as a function of a period of time which is specific to the (expected) user movement, for example over 1 second. It may also be provided that a pattern recognition is carried out (separately) for the first sum and/or second sum, in particular prior to folding. Folding or a convolution can be used preferably, as this allows the symmetrical nature (back and forth movement) of a user action, in particular a kicking movement, to be recognized comparatively well. It can be provided that normalizing and/or scaling the convolution function is carried out, for example to a value range from 0 to 1000, in particular dimensionless and/or having a.u. [arbitrary units].

In the context of the invention, it is preferably possible that determining comprises fitting a fit function to the receiving sequence, in particular to the convolution function, in order to obtain a movement profile, wherein detecting a user movement is carried out as a function of the movement profile.

Fitting can be carried out using a parabolic function. This allows the curve of the convolution function to be smoothed. It may also be provided that the fit function has at least a straight line and/or a linear fit function. This allows the method or fitting to be carried out in a particularly robust manner. For example, the incline can be predefined in a certain range, which is specific to a user movement. It may be provided that when a user movement is detected, the electronic control unit outputs a control signal. In the process, operating the vehicle or a movable part can be carried out as a function of the control signal. It may be provided that the fit function is designed as a function of predefined boundary conditions, for example fit parameters, minimum value, maximum value and/or (time) range. This can prevent false detections, for example triggered by animals such as a stray cat near the vehicle.

Furthermore, it may be provided in the context of the invention that fitting a fit function to the receiving sequence, in particular to the convolution function, comprises a first fitting of a first fit function, in particular to a rising edge of the convolution function, and a second fitting of a second fit function, in particular to a falling edge of the convolution function, in order to obtain a movement profile.

The fit function can therefore be designed in two parts. In a first fitting, an initial fit function, preferably a linear fit function, can be fitted to a rising edge of the convolution function, which is in particular specific for a toward movement, e.g. of the user's foot during a kicking movement. In a second fitting, a second fit function, preferably a linear fit function, can be fitted to a falling edge of the convolution function, which is particularly specific for an away movement, e.g. of the user's foot during a kicking movement. The movement profile may comprise the first fit function and the second fit function, wherein these are preferably arranged next to one another or one after the other. The movement profile can therefore be triangular and/or pyramid-shaped. It may be provided that the first fit function and/or second fit function (respectively) have boundary conditions (described below), in particular (permissible) fit parameters (ranges), minimum value, maximum value and/or (time) range. The boundary conditions can be specific to the vehicle, the transmitting antenna, the receiving antenna, the user movement and/or the user. It may be provided that a first touchdown point (along the y-direction) is determined for the first fit function, which is set up to filter out the edge area of the rising edge (by ignoring smaller values during fitting) and/or to be used as the first starting point for the first fit function. The first touchdown point can preferably have a value between 10% and 50%, in particular between 20% and 40%, preferably between 28% and 33%, of the value range of the convolution function, in particular if said convolution function has been scaled or normalized. It may be provided that a second touchdown point (along the y-direction) is determined for the second fit function, which is set up to filter out the edge area of the falling edge (by ignoring smaller values during fitting) and/or to be used as a second starting point for the second fit function. The second touchdown point can preferably have a value between 10% and 50%, in particular between 20% and 40%, preferably between 28% and 33%, of the value range of the convolution function, in particular if said convolution function has been scaled or normalized. It may be provided that a first fitting is (only) carried out for a range above (for larger x-values or points in time) the first touchdown point. It may be provided that a second fitting is (only) carried out for a range below (for smaller x-values or points in time) the first touchdown point. It may be provided that an intersection of the first and second fit function is determined.

It may be provided that a user movement is detected when:
a first slope of the first fit function lies within a first slope range, and/or
a second slope of the second fit function lies within a second slope range, and/or
the first slope and the second slope are identical in terms of magnitude or (only) differ by a maximum of 50%, in particular 40%, for example 30%, preferably 20%, particularly preferably 10%, and/or
a first distance between a first touchdown point and an intersection of the first and second fit function and a second distance between a second touchdown point and the intersection of the first and second fit function differ (in terms of magnitude) at most by a value between 1% and 50%, in particular between 2% and 40%, preferably between 3% and 30%, preferably between 4% and 20%, particularly preferably between 5% and 15%.

With reference to the present invention, it is conceivable that determining comprises calculating a deviation between the movement profile, in particular the fit function, and the convolution function, wherein in particular a control signal for operating the vehicle is (only) output if the deviation is below a predefined limit value (e.g. deviation limit value).

It may be provided that the deviation is calculated only in a range between the first and second touchdown point. This prevents errors that can arise due to edge areas. It may be provided that the deviation is specific for a quality of the receiving sequence, in particular the convolution function and/or (first and/or second) fit function. This advantageously makes it possible to sort out incorrect measurements. The deviation can be carried out by calculating a sum of a (squared) deviation between the fit function and the convolution function, in particular between the first fit function and the rising edge and/or between the second fit function and the falling edge. A first deviation between the first fit function and the rising edge of the convolution function can be calculated. A second deviation between the second fit function and the falling edge of the convolution function can be calculated. The deviation can comprise the first and second deviation (e.g. the sum of both). The deviation can be a (cumulative) sum of the (square and/or absolute) difference(s) of the corresponding values, e.g. for the different points in time. It may be provided that a user movement is detected when:
the deviation (in total) does not exceed a deviation limit value, wherein the deviation limit value is predefined (e.g. the deviation limit value may comprise a difference between a y-value of the first or second touchdown point and the y-value of an intersection of the first and second fit function), is determined empirically, is determined by a calibration (e.g. as part of a commissioning), and/or is determined by a machine-learned classifier, and/or
the first deviation does not exceed a first deviation limit value, and/or
the second deviation does not exceed a second deviation limit.

Furthermore, it is conceivable that determining comprises comparing the receiving sequence, in particular the movement profile, with a predefined movement profile, wherein
a control signal is output if the movement profile matches the predefined movement profile,
no control signal is output if the movement profile does not match the predefined movement profile.

The predefined movement profile can be specific to a user movement. The predefined movement profile can be stored in the electronic control unit, determined by calibration, determined by pattern recognition and/or determined by a machine-learned classifier. During comparing, a deviation between the movement profile and the predefined movement profile can be determined. It may be provided that a match is determined if the deviation, in particular in relation to the area, has a cumulative deviation and/or a mean square deviation of less than 100%, in particular less than 50%, for example less than 40%, preferably less than 25%, particularly preferably less than 15%, ideally less than 5%. It may be provided that comparing is (only) carried out for a range between the first and second touchdown points.

The above object is achieved according to a second aspect by a computer program product according to the invention, comprising instructions which, when the computer program product is executed by a computer, cause the computer to implement the method according to the first aspect.

This results in the same advantages with respect to a computer program product according to the invention as have already been described with respect to a method according to the invention according to the first aspect.

The above object is achieved according to a third aspect by a computer-readable data carrier according to the invention, in which instructions are stored which, when executed by a computer, cause the computer to carry out the method according to the first aspect.

This results in the same advantages with respect to a computer-readable data carrier according to the invention as have already been described with respect to a method according to the invention according to the first aspect and/or a computer program product according to the invention according to the second aspect.

The above object is achieved according to a fourth aspect by an electronic control unit having a computing unit and a memory unit in which instructions are stored which, when at least partially executed by the computing unit, carry out a method according to the first aspect.

This results in the same advantages with respect to an electronic control unit according to the invention as have already been described with respect to a method according to the invention according to the first aspect and/or a computer program product according to the invention according to the second aspect and/or a computer-readable data carrier according to the invention according to the third aspect.

The above object is achieved according to a fifth aspect by a vehicle according to the invention, comprising an electronic control unit according to the fourth aspect.

This results in the same advantages with respect to a vehicle according to the invention as have already been described with respect to a method according to the invention according to the first aspect and/or a computer program product according to the invention according to the second aspect and/or a computer-readable data carrier according to the invention according to the third aspect and/or an electronic control unit according to the invention according to the fourth aspect.

### BRIEF DESCRIPTION OF THE DRAWINGS

Further advantages, features, and details of the invention are apparent from the following description, in which several embodiment examples of the invention are described in detail with reference to the drawings. Here, the features mentioned in the description can each be essential to the invention individually or in any combination. In the drawings:

FIG. 1 is a method,

FIG. 2 is a vehicle,

FIG. 3 is a first sum and a second sum, and

FIG. 4 is a convolution function.

In the figures, the same technical features, including those of different embodiment examples, are represented by identical reference signs.

### DETAILED DESCRIPTION OF THE CURRENT EMBODIMENT

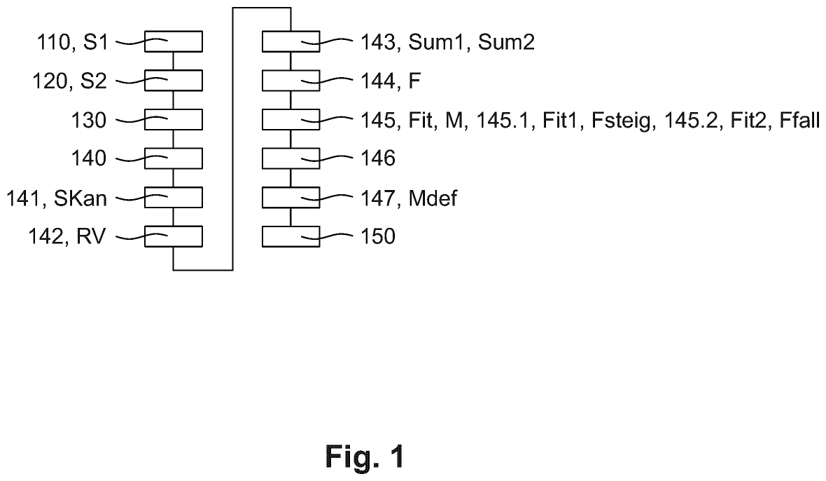

FIG. 1 shows a method for detecting a user movement of a user 300 in a vehicle 200, in particular for detecting the presence of a user 300 at or in the vehicle 200, comprising:
transmitting 110, using a transmitting antenna 10 of a vehicle 200, a transmitting sequence S1,
receiving 120, using a receiving antenna 20, a receiving sequence S2, the receiving sequence S2 being designed at least partially as a function of the transmitting sequence S1 reflected at a user 300 of the vehicle 200,
transmitting 130 the receiving sequence S2 to an electronic control unit ECU of the vehicle 200,
determining 140, by the electronic control unit ECU, a user movement of the user 300 as a function of the receiving sequence S2, and
operating 150, by the electronic control unit ECU, the vehicle 200 as a function of determining 140.

In the context of the invention, it may be advantageous for the transmitting antenna 10 and/or the receiving antenna 20 to be designed as an ultra-wideband UWB antenna and for transmitting 110 of a transmitting sequence S1 to have a bandwidth of at least 500 MHz.

In the context of the invention, it is conceivable that receiving 120 or determining 140 comprises calculating 141 a, in particular time-invariant, channel impulse response SKan as a function of the receiving sequence S2.

In the context of the invention, it may be provided that determining 140 comprises calculating 142 a two-dimensional Fourier transform, in particular a Fast Fourier transform, as a function of the receiving sequence S2, in particular the channel impulse response SKan, in order to obtain a distance-velocity map RV.

It is further conceivable that determining 140 comprises forming 143, in particular repeatedly, a first sum Sum1 and a second sum Sum2 as a function of the receiving sequence S2, in particular the distance-velocity map RV, wherein the first sum Sum1 is specific to a movement of the user 300, in particular a leg of the user 300, towards the transmitting antenna 10, wherein the second sum Sum2 is specific to a movement of the user 300, in particular a leg of the user 300, away from the transmitting antenna 10.

It is also conceivable that determining 140 comprises folding 144 the receiving sequence S2, wherein in particular the first sum Sum1 is folded with the second sum Sum2 in order to obtain a convolution function F.

In the context of the invention, it is optionally possible that determining 140 comprises fitting 145 a fit function Fit to the receiving sequence S2, in particular to the convolution function F, in order to obtain a movement profile M, wherein detecting a user movement is carried out as a function of the movement profile M.

Furthermore, it may be provided in the context of the invention that fitting 145 a fit function Fit to the receiving sequence S2, in particular to the convolution function F, comprises a first fitting 145.1 of a first fit function Fit1, in particular to a rising edge Fsteig of the convolution function F, and a second fitting 145.2 of a second fit function Fit2, in particular to a falling edge Ffall of the convolution function F, in order to obtain a movement profile M.

With reference to the present invention, it is conceivable that determining 140 comprises calculating 146 a deviation between the movement profile M, in particular the fit function Fit, and the convolution function F, wherein in particular a control signal for operating 150 the vehicle 200 is output only if the deviation is below a predefined limit value.

Furthermore, it is conceivable that determining 140 comprises comparing 147 the receiving sequence S2, in particular the movement profile M, with a predefined movement profile Mdef, wherein:
a control signal is output if the movement profile M matches the predefined movement profile Mdef,
no control signal is output if the movement profile M does not match the predefined movement profile Mdef.

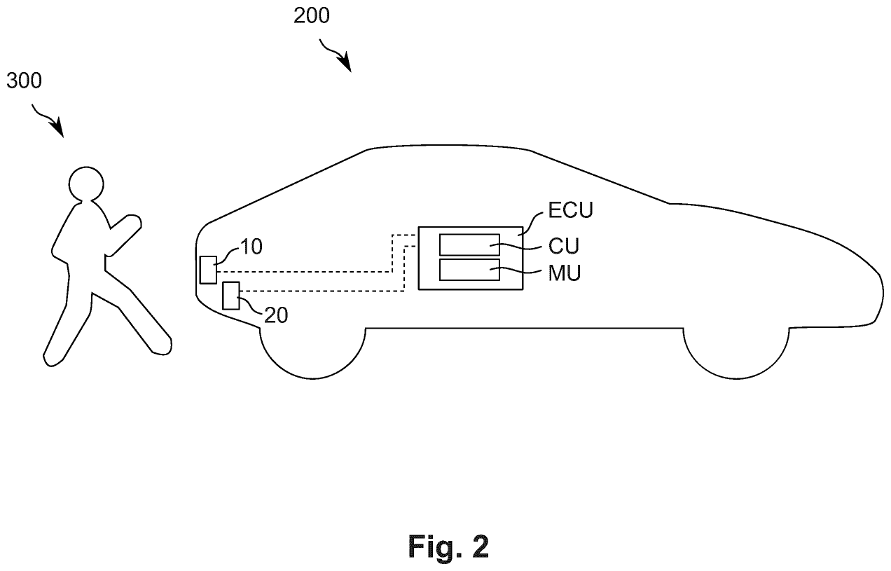

FIG. 2 shows a vehicle 200 according to the invention, comprising an electronic control unit ECU having a computing unit CU and a memory unit MU. The vehicle 200 comprises a transmitting antenna 10 and a receiving antenna 20, wherein these can be integrated, for example in a (uniform) UWB sensor. The transmitting antenna 10 and/or the receiving antenna 20 may be connected to the electronic control unit ECU in a data-communicating manner via a data connection (shown in dashed lines). A transmitting sequence S1 can be emitted by the transmitting antenna 10 and preferably reflected (at least partially) at a user 300, for example the user's leg. The receiving antenna 20 can receive a corresponding receiving sequence S2 and preferably transmit it to the electronic control unit ECU.

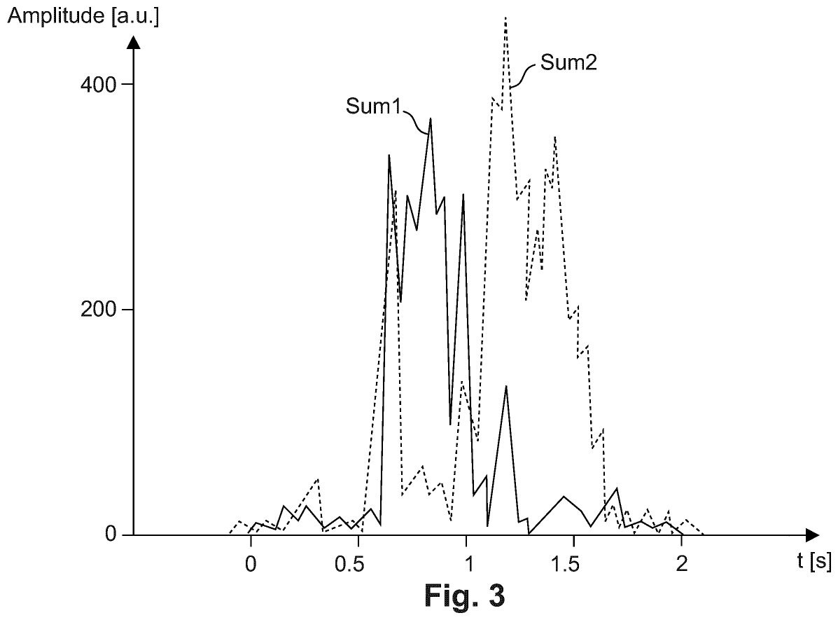

FIG. 3 shows a first sum Sum1 and a second sum Sum2 as a function of time t (here in seconds [s]). The y-axis or the amplitude is shown dimensionless and/or in “arbitrary units” [a.u.]. The first sum Sum1 and the second sum Sum2 can exhibit a time offset.

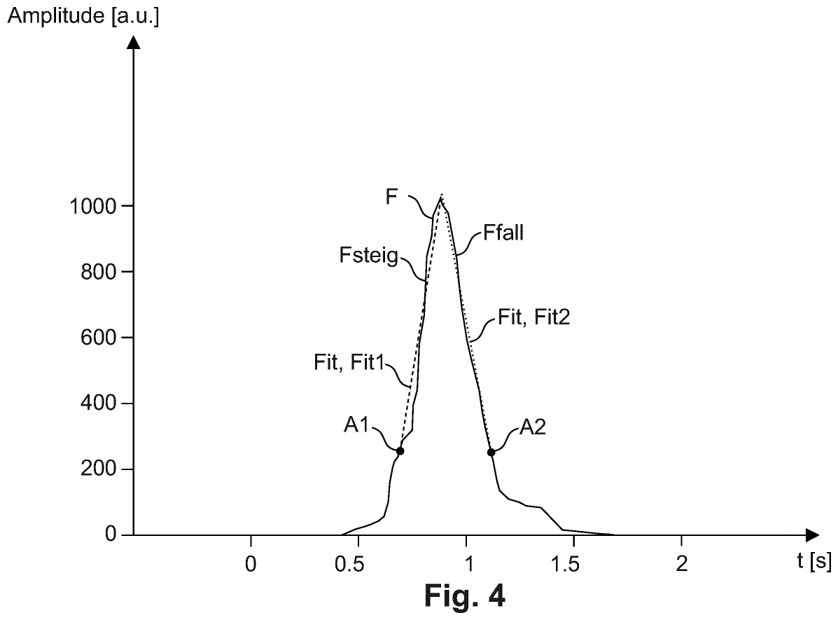

FIG. 4 shows an example of a convolution function F, which can be obtained, for example, starting from FIG. 3 or the first and second sum Sum1, Sum2. The convolution function F has a rising edge Fsteig, to which a fit function Fit, in particular a first fit function Fit1, can be fitted, in particular starting from a first touchdown point A1. The convolution function F has a falling edge Ffall, to which a fit function Fit, in particular a second fit function Fit2, can be fitted, in particular starting from a second touchdown point A2. The first fit function Fit1 and the second fit function Fit2 intersect.

### LIST OF REFERENCE NUMBERS

10 transmitting antenna
20 receiving antenna
110 transmitting a transmitting sequence
120 receiving a receiving sequence
130 transmitting the receiving sequence
140 determining a user movement
141 calculating a channel impulse response
142 calculating a two-dimensional Fourier transform
143 forming a first sum and a second sum
144 folding the receiving sequence
145 fitting a fit function to the receiving sequence
145.1 first fitting of a first fit function
145.2 second fitting of a second fit function
146 calculating a deviation between the movement profile and the convolution function
147 comparing the receiving sequence with a predefined movement profile
150 operating the vehicle
200 vehicle
300 user
A1 first touchdown point
A2 second touchdown point
ECU electronic control unit
CU computing unit
MU memory unit
F convolution function
Fit fit function
Fit1 first fit function
Fit2 second fit function
Fsteig rising edge
Ffall falling edge
M movement profile
Mdef predefined movement profile
RV distance-velocity map
S1 transmitting sequence
S2 receiving sequence
SKan channel impulse response
Sum1 first sum
Sum2 second sum
t time

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for detecting a movement of a user in a vehicle, comprising:
transmitting, using a transmitting antenna of the vehicle, a transmitting sequence;
receiving, using a receiving antenna, a receiving sequence, the receiving sequence being designed at least partially as a function of the transmitting sequence reflected at the user of the vehicle;
transmitting the receiving sequence to an electronic control unit of the vehicle;
determining, by the electronic control unit, a movement of the user as a function of the receiving sequence; and
operating, by the electronic control unit, the vehicle as a function of the determined movement of the user.

2. The method according to claim 1, wherein the transmitting antenna or the receiving antenna are configured as an ultra-wideband antenna and wherein the transmission of the transmitting sequence has a bandwidth of at least 500 MHz.

3. The method according to claim 1, wherein the receiving step or the determining step comprises calculating time-invariant channel impulse response as a function of the receiving sequence.

4. The method according to claim 1, wherein determining a movement of the user comprises calculating a two-dimensional Fourier transform as a function of the receiving sequence in order to obtain a distance-velocity map.

5. The method according to claim 1, wherein determining a movement of the user comprises repeatedly forming a first sum and a second sum as a function of the receiving sequence, wherein the first sum is specific to a movement of the user toward the antenna, and wherein the second sum is specific to a movement of the user away from the transmitting antenna.

6. The method according to claim 1, wherein determining a movement of the user comprises folding the receiving sequence, wherein the first sum is folded with the second sum in order to obtain a convolution function.

7. The method according to claim 6, wherein determining a movement of the user comprises fitting a fit function to the convolution function in order to obtain a movement profile, the user movement being detected as a function of the movement profile.

8. The method according to claim 7, wherein fitting a fit function comprises a first fitting of a first fit function to a rising edge of the convolution function, and a second fitting of a second fit function to a falling edge of the convolution function, in order to obtain the movement profile.

9. The method according to claim 8, wherein determining a movement of the user further comprises calculating a deviation between the first fit function and the convolution function, wherein a control signal of the vehicle is output only if the deviation is below a predefined limit value.

10. The method according to claim 7, wherein determining a movement of the user comprises comparing the movement profile with a predefined movement profile, wherein a control signal is output only if the movement profile matches the predefined movement profile.

11. A computer program product comprising instructions which, when executed by a computer, cause the computer to implement the method of claim 1.

12. A computer-readable data carrier in which instructions are stored which, when executed by a computer, cause the computer to implement the method of claim 1.

13. An electronic control unit having a computing unit and a memory unit, in which instructions are stored which, when at least partially executed by the computing unit, carry out the method of claim 1.

14. A vehicle comprising the electronic control unit of claim 13.
